(19) United States
(12) Patent Application Publication
(10) Pub. No.: US 2025/0036169 A1
(43) Pub. Date: Jan. 30, 2025

(54) FOLDABLE COMPUTING DEVICE

(71) Applicant: Samsung Electronics Co., Ltd., Suwon-si (KR)

(72) Inventor: Chaoqun WEI, Suzhou (CN)

(73) Assignee: Samsung Electronics Co., Ltd., Suwon-si (KR)

(21) Appl. No.: 18/806,331

(22) Filed: Aug. 15, 2024

Related U.S. Application Data
(63) Continuation of application No. PCT/IB2024/056745, filed on Jul. 11, 2024.

(30) Foreign Application Priority Data
Jul. 26, 2023 (CN) 202310925534.4

(51) Int. Cl. G06F 1/16; G09F 9/30

(52) U.S. Cl. CPC G06F 1/1681; G06F 1/1652; G09F 9/301

(57) ABSTRACT

Disclosed is a foldable computing device, comprising, a host case; a first enclosure pivotally coupled to the back side of the host case via a first hinge; a second enclosure pivotally coupled to the front side of the first enclosure via a second hinge; a flexible display panel attached to the first enclosure and the second enclosure; and a locking unit arranged between the first enclosure and the second enclosure, which is configured for locking the first enclosure and the second enclosure together after the second enclosure being opened from the first enclosure, or, unlocking the first enclosure and the second enclosure before the second enclosure being closed onto the first enclosure.

### CROSS-REFERENCE TO RELATED APPLICATIONS

This application is a by-pass continuation application of International Application No. PCT/IB2024/056745, filed on Jul. 11, 2024, which is based on and claims priority to Chinese Patent Application No. CN 202310925534.4, filed on Jul. 26, 2023, in the Chinese Patent and Trademark Office, the disclosure of each of which is incorporated by reference herein in its entirety.

### BACKGROUND

### 1. Field

The disclosure relates to the field of computer technology, and more particularly to foldable computing devices.

### 2. Description of Related Art

A traditional notebook computer is assembled by connecting two bodies through a pivotal connection structure. Typically, one body is equipped with a motherboard and a power supply system as the host part of the notebook computer, and the other body is equipped with a display panel. The display panel is connected to the host part through the pivotal connection structure via physical wiring or a soft board connection to obtain the display signal and the power supply required for operation. The pivotal connection structure is normally disposed between the display case and the host case, and the pivotal connection structure is located in the accommodation space for accommodating the above-mentioned pivot structure. In other words, the connection structure is configured to accommodate the pivot structure connecting between the display case and the host case. Accordingly, the display case can be relatively moved (i.e., rotated) with respect to the host case. In addition, the connection structure can further decorate or modify the appearance of the laptop computer. In some embodiments, the connection structure can be directly or indirectly connected to the keyboard frame. In some embodiments, the connection structure can be directly or indirectly connected to the bottom cover. In some embodiments, the connection structure can be directly or indirectly connected to both the keyboard frame and the bottom cover. However, the screen size of the traditional notebook computer is generally fixed, providing many inconvenient problems. Small-size notebooks are easy to move, but not conducive for long-term use with a smaller screen. Large-size notebooks are conducive for long-term use but inconvenient for carrying with a larger screen size and a higher weight.

### SUMMARY

According to an aspect of the disclosure, a foldable computing device includes: a host case; a first enclosure pivotally coupled to a back side of the host case via a first hinge; a second enclosure pivotally coupled to a front side of the first enclosure via a second hinge; a flexible display panel attached to the first enclosure and the second enclosure; and a locking unit between the first enclosure and the second enclosure, wherein the locking unit is configured to lock the first enclosure and the second enclosure together after the second enclosure is opened from the first enclosure, or to unlock the first enclosure and the second enclosure before the second enclosure is closed onto the first enclosure.

The first hinge and the second hinge may each have a 360 degree range of rotation.

A first end of the second hinge may be pivotally connected with the front side of the first enclosure, and a second end of the second hinge may be pivotally connected with the back side of the second enclosure.

The second hinge may include a first hinge plate, a second hinge plate, and a pin, each of the first and the second hinge plates may include a plate body and a plurality of pin lugs distributed along each side of the plate body, the plurality of pin lugs of the first and the second hinge plates may interlock with one another, the pin may inserted through the interlocked pluralities of pin lugs of the first and the second hinge plates, and the first and the second hinge plates may be pivotally connected with each other.

The foldable computing device may further include: an outer protective cover on an outer side of the second hinge; and a flexible screen supporting plate under the flexible display panel, and the flexible screen supporting plate may be arranged on an inner side of the second hinge.

A notch may be formed between the first enclosure and the second enclosure, and the flexible screen supporting plate may be movably arranged within the notch.

The locking unit may include a first movable bolt movably arranged inside the second enclosure, the first movable bolt may be configured to protrude from the second enclosure and lock with the first enclosure after the second enclosure is opened from the first enclosure, and the first movable bolt may be configured to retract from the first enclosure into the second enclosure before the second enclosure is closed onto the first enclosure.

The locking unit may further include a second movable bolt movably arranged inside the second enclosure, the second movable bolt may be configured to protrude from the second enclosure and lock with the first enclosure after the second enclosure is opened from the first enclosure, the second movable bolt may be configured to retract from the first enclosure into the second enclosure before the second enclosure is closed onto the first enclosure. The first and the second movable bolt may be respectively arranged on each side of the second hinge, and both the second hinge and the first and the second movable bolts may be covered by the outer protective cover.

The locking unit may further include: a first spring on a back end of the first movable bolt; a fixing hook disposed within the second enclosure and a second spring, wherein the fixing hook is connected with a front side of the flexible screen supporting plate via the second spring; and a release button connected to an end of the fixing hook. A front end of the first movable bolt may include a fixing groove, and the fixing hook may be configured to be drawn into the fixing groove by the second spring. In response to the release button being pressed, the fixing hook may be configured to move out of the fixing groove. In response to the fixing hook moving out of the fixing groove, the first spring may be configured to cause the first movable bolt to elastically protrude from the second enclosure under an elastic force of the first spring and to insert into a corresponding connecting hole in the first enclosure.

The first movable bolt may include an operation part outside the second enclosure, and in response to the operation part being pushed, the first movable bolt may be configured to retract from the first enclosure into the second enclosure under the elastic force of the first spring, and the fixing hook may be configured to be drawn into the fixing groove by the second spring.

The front of the host case may include a supporter configured to support the second enclosure after it is closed onto the first enclosure.

The host case may include a keyboard and a hidden touchpad.

The host case may include a motherboard and a power supply system.

According to an aspect of the disclosure, a foldable computing device includes: a first enclosure and a second enclosure, wherein the second enclosure is pivotally coupled to a front side of the first enclosure; and a locking unit between the first enclosure and the second enclosure, wherein the locking unit is configured to lock the first enclosure and the second enclosure together after the second enclosure is opened from the first enclosure, or to unlock the first enclosure and the second enclosure before the second enclosure is closed onto the first enclosure, wherein the locking unit comprises a first movable bolt movably arranged inside the second enclosure, and wherein the first movable bolt is configured to protrude from the second enclosure and lock with the first enclosure after the second enclosure is opened from the first enclosure, and the first movable bolt is configured to retract from the first enclosure into the second enclosure before the second enclosure is closed onto the first enclosure.

The foldable computing device may further include: a hinge; and an outer protective cover. The locking unit may further include a second movable bolt movably arranged inside the second enclosure. The second movable bolt may be configured to protrude from the second enclosure and lock with the first enclosure after the second enclosure is opened from the first enclosure, and the second movable bolt may be configured to retract from the first enclosure into the second enclosure before the second enclosure is closed onto the first enclosure. The first and the second movable bolts may be respectively arranged on each side of the hinge, and both the hinge and the first and the second movable bolts may be covered by the outer protective cover.

The foldable computing device may further include: a flexible display panel attached to the first enclosure and the second enclosure; and a flexible screen supporting plate under the flexible display panel; wherein the first enclosure and the second enclosure are pivotally connected via the hinge, the outer protective cover is on an outer side of the hinge, and the flexible screen supporting plate is arranged on an inner side of the hinge, wherein the locking unit further comprises a first and a second locking assembly, wherein each of the first and the second locking assemblies comprises: one of the first and the second movable bolts, wherein each of the first and the second movable bolts comprises a fixing groove, a first spring on a back end of the one of the first and the second movable bolts; a fixing hook disposed within the second enclosure; a second spring; and a release button, and wherein, for each of the first and the second locking assemblies: the fixing hook is connected to a front side of the flexible screen supporting plate via the second spring, and the release button is connected to an end of the fixing hook, the fixing hook is configured to be drawn into the fixing groove by the second spring, in response to the release button being pressed, the fixing hook is configured to move out of the fixing groove, and in response to the fixing hook moving out of the fixing groove, the first spring is configured to cause the one of the first and the second movable bolt to elastically protrude from the second enclosure under an elastic force of the first spring and to insert into a corresponding connecting hole in the first enclosure.

Each of the first and the second movable bolts may include an operation part outside the second enclosure, and for each of the first and the second locking assemblies, in response to the operation part being pushed, the one of first and the second movable bolts may be configured to retract from the first enclosure into the second enclosure under the elastic force of the first spring, and the fixing hook may be configured to be drawn into the fixing groove by the second spring.

The hinge may have a 360 degree range of rotation.

A first end of the hinge may be pivotally connected with a front side of the first enclosure, and a second end of the hinge may be pivotally connected with a back side of the second enclosure.

The hinge may include a first hinge plate, a second hinge plate, and a pin. Each of the first and the second hinge plates may include a plate body and a plurality of pin lugs distributed along each side of the plate body. The plurality of pin lugs of the first and the second hinge plates may interlock with one another, and the pin may be inserted through the interlocked pluralities of pin lugs of the first and the second hinge plates. The first and the second hinge plates may be pivotally connected with each other.

The foregoing provides electronic products of lightweight, thin structure which are easy to assemble. The display part can be folded to 0° or 360°, also opened to 180°, providing the electronic products with a notebook mode, a pad mode, a presentation pad mode, and a closed mode.

### BRIEF DESCRIPTION OF DRAWINGS

The above and other aspects, features, and advantages of certain embodiments of the present disclosure will be more apparent from the following detailed description taken in conjunction with the accompanying drawings, in which:

FIG. 1 is an exploded view showing a foldable computing device according to an embodiment of the disclosure;

FIG. 2 is a schematic view showing a foldable computing device in a closed mode according to an embodiment of the disclosure;

FIG. 3 is a side view showing a foldable computing device in a closed mode according to an embodiment of the disclosure;

FIG. 4 is a partially enlarged view showing the portion of A-1 in FIG. 3;

FIG. 5 is a schematic view showing the internal structure of a second hinge of a foldable computing device according to an embodiment of the disclosure;

FIG. 6 is an exploded view showing a second hinge of a foldable computing device according to an embodiment of the disclosure;

FIG. 7 is a partially enlarged view showing the portion of A-2 in FIG. 3;

FIG. 8 and FIG. 9 are schematic views showing a locking process of a locking unit of a foldable computing device according to an embodiment of the disclosure;

FIG. 10 is a schematic view showing a foldable computing device in a notebook mode according to an embodiment of the disclosure;

FIG. 11 is a schematic view showing a foldable computing device in a presentation pad mode according to an embodiment of the disclosure;

FIG. 12 and FIG. 13 are schematic views showing an unlocking process of a locking unit of a foldable computing device according to an embodiment of the disclosure;

FIG. 14 is a schematic view showing a foldable computing device in a pad mode according to an embodiment of the disclosure;

FIG. 15 is a side view showing a foldable computing device in a pad mode according to an embodiment of the disclosure;

FIG. 16 is a partially enlarged view showing the portion of B-1 in FIG. 15; and

FIG. 17 is a partially enlarged view showing the portion of B-2 in FIG. 15.

### DETAILED DESCRIPTION

All terms including descriptive or technical terms which are used herein should be construed as having meanings that are understood to one of ordinary skill in the art. However, the terms may have different meanings according to an intention of one of ordinary skill in the art, precedent cases, or the appearance of new technologies. In addition, some terms may be selected by the applicant, and in this case, the meaning of the selected terms will be described in detail in the detailed description of embodiments. Thus, the terms used herein have to be defined based on the meaning of the terms together with the description throughout the specification.

Also, when a part “includes” or “comprises” an element, unless there is a particular description contrary thereto, the part may further include other elements, not excluding the other elements. In the following description, terms such as “unit” and “module” indicate a unit for processing at least one function or operation, wherein the unit and the block may be embodied as hardware or software or embodied by combining hardware and software.

The embodiments will now be described more fully with reference to the accompanying drawings. However, the embodiments may be embodied in many different forms, and should not be construed as being limited to the embodiments set forth herein. Rather, these embodiments are provided so that this disclosure will be thorough and complete, and will fully convey the concept of the embodiments to one of ordinary skill in the art. In the following description, well-known functions or constructions are not described in detail because they would obscure the embodiments with unnecessary detail, and like reference numerals in the drawings denote like or similar elements throughout the specification.

Herein, the expressions “at least one of a, b or c” and “at least one of a, b and c” indicate “only a,” “only b,” “only c,” “both a and b,” “both a and c,” “both b and c,” and “all of a, b, and c.”

In some examples, the foldable computing device is a laptop computing device. In some examples, the computing device is a smartphone, tablet, or other computing device having a foldable (e.g., flexible) display panel. Generally, the foldable computing device may be any type of computing device that has two or more enclosures that are connected via one or more hinges. It may have antennas for sending and/or receiving wireless signals (e.g., radio frequency signals) such that the computing device may wirelessly communicate with another device. In some examples, the antenna is a Wi-Fi antenna. In some examples, the antenna is a Wi-Fi antenna configured to operate at one or more frequency bands. In some examples, the antenna is a short-range antenna (e.g., near-field communication (NFC) antenna, Bluetooth antenna).

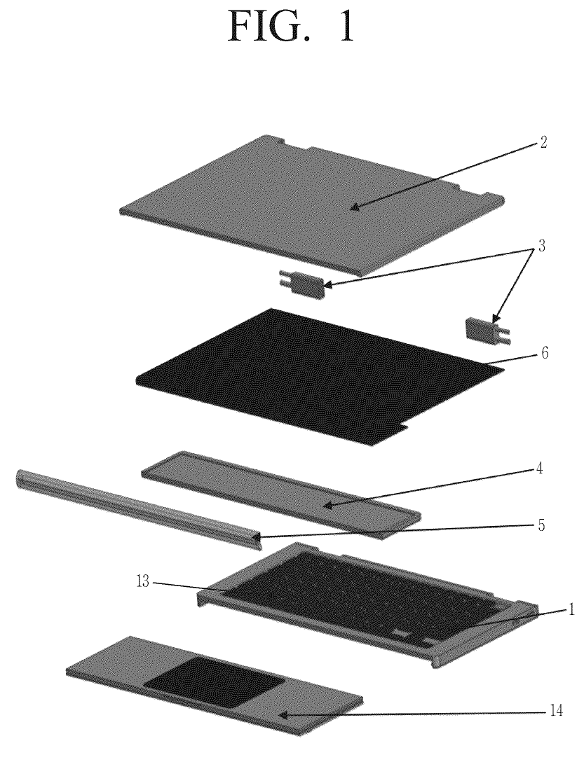

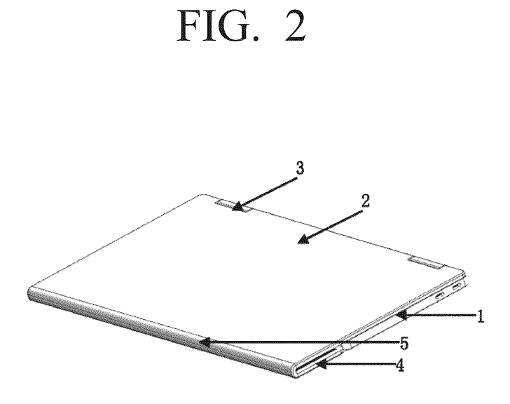

FIG. 1 is an exploded view showing the foldable computing device according to an embodiment of the disclosure. FIG. 2 is a schematic view showing the foldable computing device in a closed mode according to an embodiment of the disclosure. The foldable computing device according to an embodiment of the disclosure may include a host case 1, a first enclosure 2, a second enclosure 4, a flexible display panel 6, and other electronic components. The host case 1 may be provided with a keyboard 13 and a hidden touchpad 14. The host case 1 may include a motherboard and a power supply system. The first enclosure 2 may be pivotally coupled to the back side of the host case 1 via a first hinge 3. The second enclosure 4 may be pivotally coupled to the front side of the first enclosure 2 via a second hinge 5. The flexible display panel 6 may be attached to the first enclosure 2 and the second enclosure 4. The first hinge 3 and the second hinge 5 are configured to be 360-degree rotatable. The locking unit may be arranged between the first enclosure 2 and the second enclosure 4, and may be configured to lock the first enclosure 2 and the second enclosure 4 together after the second enclosure 4 is opened from the first enclosure 2, or unlocking the first enclosure 2 and the second enclosure 4 before the second enclosure 4 is closed onto the first enclosure 2. The locking unit can keep the flexible display panel 6 opening from shaking or flipping.

In some examples, the first enclosure 2 and the second enclosure 4 include a bezel extending around a perimeter area of the first enclosure 2 and the second enclosure 4, where the bezel secures the flexible display panel 6 to the first enclosure 2 and the second enclosure 4. In some examples, the first enclosure 2 and the second enclosure 4 are conductive-based enclosures (e.g., a conductive or metal enclosure). In one or more embodiment, the first enclosure 2 and the second enclosure 4 are constructed from one or more conductive materials such as magnesium, alloy, titanium, copper, aluminum, gold, silver, etc. In one or more embodiments, the first enclosure 2 and the second enclosure 4 are entirely conductive (e.g., entirely metal).

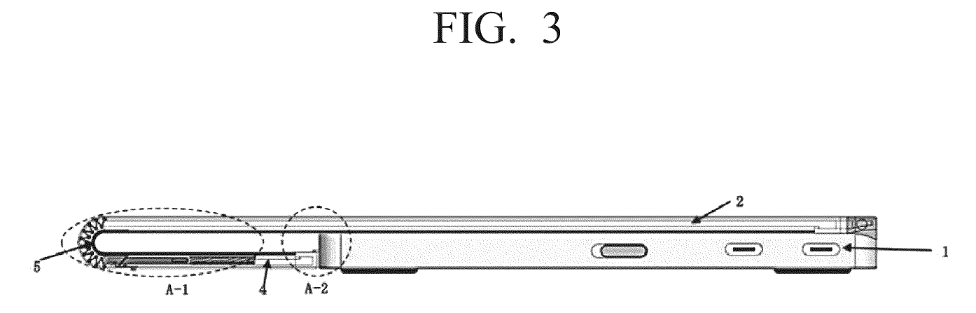

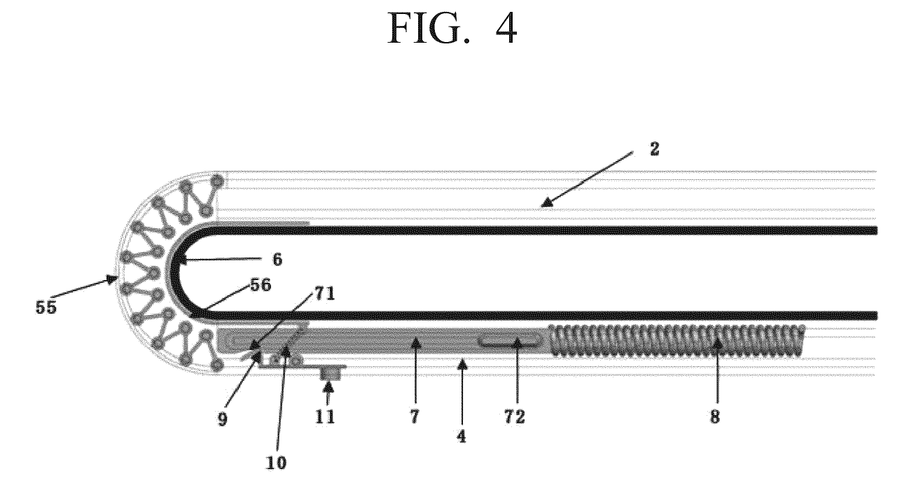

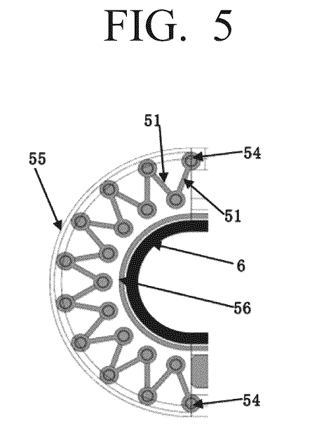

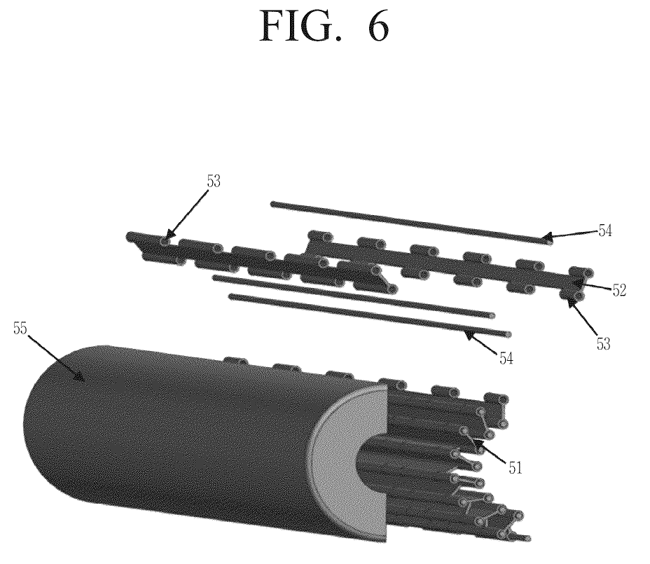

FIG. 3 is a side view showing the foldable computing device in a closed mode according to an embodiment of the disclosure. FIG. 4 is a partially enlarged view showing the portion of A-1 in FIG. 3. FIG. 5 is a schematic view showing the internal structure of the second hinge of the foldable computing device according to an embodiment of the disclosure. FIG. 6 is an exploded view showing the second hinge of the foldable computing device according to the disclosure.

One end of the second hinge 5 may be pivotally connected with the front side of the first enclosure 2, and the other end of the second hinge 5 may be pivotally connected with the back side of the second enclosure 4. The second hinge 5 may include a plurality of hinge plates 51 pivotally connected with each other. Each hinge plate 51 may include a plate body 52 and several pin lugs 53 formed such that they are spaced apart on both sides of the plate body 52. The pin lugs 53 on neighboring hinge plates 51 interlock (cross) with each other for inserting pin 54 to assemble into one body. Torque is generated by providing a tight fit between the pin 54 and the hinge plate 51 to ensure fixation when the flexible display panel 6 is opened or closed.

An outer protective cover 55 may be arranged on the outer side of the second hinge 5, and a flexible screen supporting plate 56 supporting under the flexible display panel 6 may be arranged on the inner side of the second hinge 5. One side of the flexible screen supporting plate 56 may be fixed, and the other side may be movable. A notch in which the flexible screen supporting plate 56 is movably arranged may be formed between the first enclosure 2 and the second enclosure 4. A pair of movable bolts 7 may be respectively arranged on each side of the second hinge 5, and both the second hinge 5 and the pair of movable bolts 7 may be covered by the outer protective cover 55. In an alternative embodiment, a single bolt on one side of the second hinge 5 may be used.

The locking unit may include a pair of movable bolts 7 movably arranged inside the second enclosure 4. The movable bolts 7 may protrude from the second enclosure 4 and lock with the first enclosure 2 after the second enclosure 4 is opened from the first enclosure 2, and the movable bolts 7 may retract from the first enclosure 2 into the second enclosure 4 before the second enclosure 4 is closed onto the first enclosure 2.

The back end of each movable bolt 7 may be provided with a first spring 8. The second enclosure 4 may be provided with a fixing hook 9 which is connected with the front side of the flexible screen supporting plate 56 via a second spring 10. The second spring 10 may produce a pre-tightening force for the fixing hook 9 in the closed position to limit the movement of the bolts 7. The other end of the fixing hook 9 may be provided with a release button 11. The front end of each movable bolt 7 may be provided with a fixing groove 71 wherein the fixing hook 9 is drawn into the fixing groove 71 by the second spring 10. The fixing hook 9 may move out of the fixing groove 71 if the release button 11 is pressed, so that the movable bolts 7 elastically protrude from the second enclosure 4 under the elastic force of the first spring 8 and insert into a corresponding connecting hole in the first enclosure 2. Each movable bolt 7 may be provided with an operation part 72 outside the second enclosure 4 which is configured to push the movable bolt 7 to retract from the first enclosure 2 into the second enclosure 4 under the elastic force of the first spring 8, and the fixing hook 9 may be drawn into the fixing groove 71 by the second spring 10 again.

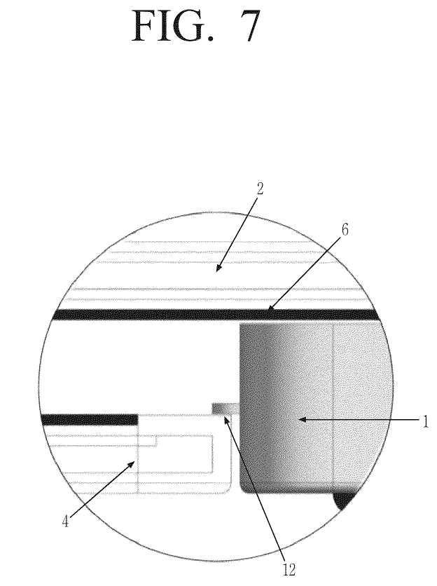

FIG. 7 is a partially enlarged view showing the portion A-2 of FIG. 3. The front of the host case 1 may be provided with a supporter 12 which is configured to support the second enclosure 4 after the second enclosure 4 is closed onto the first enclosure 2 and preventing the flexible display panel 6 from over bending (and thus cause permanent damage). Therefore, the laptop computer can be designed with higher thickness uniformity and better appearance.

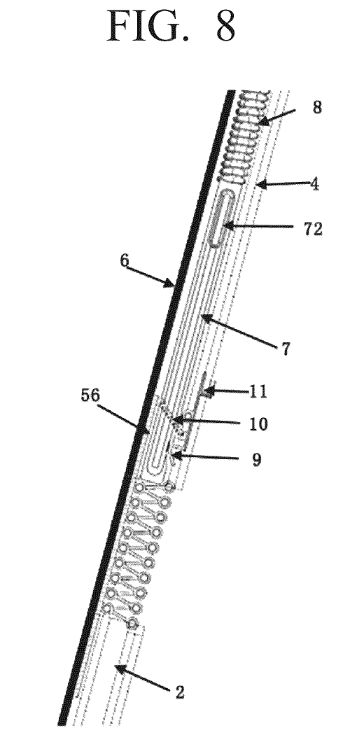

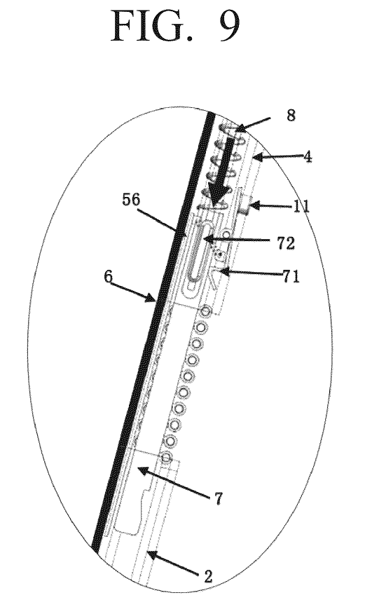

FIG. 8 and FIG. 9 are schematic views showing the locking process of the locking unit of the foldable computing device according to the disclosure. The fixing hook 9 may be drawn into the fixing groove 71 by the second spring 10. The release button 11 can be pressed to move out of the fixing hook 9 from the fixing groove 71 after the second enclosure 4 is opened from the first enclosure 2. The movable bolts 7 may then elastically protrude from the second enclosure 4 under the elastic force of the first spring 8 and insert into a corresponding connecting hole in the first enclosure 2.

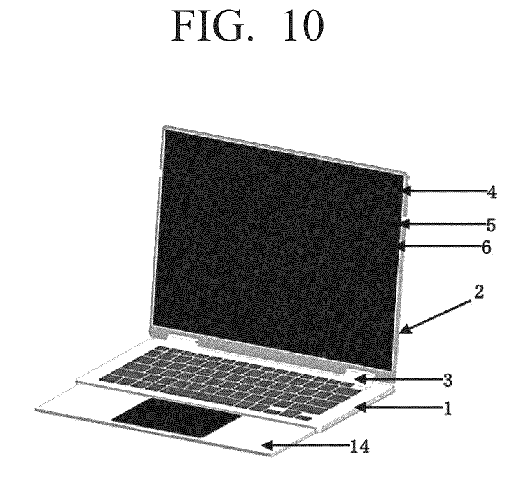

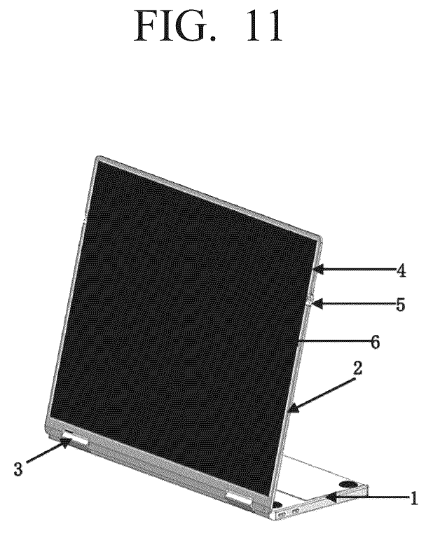

FIG. 10 is a schematic view showing the foldable computing device in a notebook mode according to an embodiment of the disclosure. The display area will be maximized once the flexible display panel 6 is fully opened. FIG. 11 is a schematic view showing the foldable computing device in a presentation pad mode according to an embodiment of the disclosure. The foldable computing device can be used as a presentation pad if the host case 1 is turned to back.

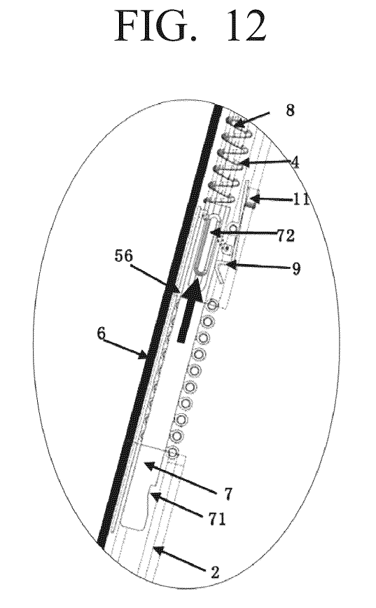

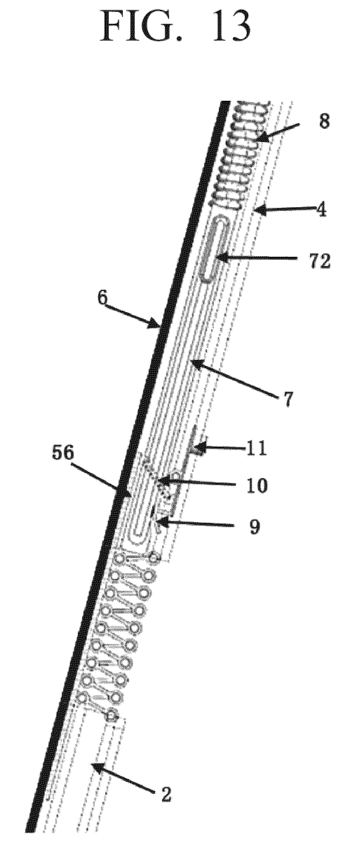

FIG. 12 and FIG. 13 are schematic views showing the unlocking process of the locking unit of the foldable computing device according to an embodiment of the disclosure. In an embodiment, if a user pushes the operation part 72 upwards, the movable bolt 7 will retract from the first enclosure 2 into the second enclosure 4 under the elastic force of the first spring 8, and the fixing hook 9 will be drawn into the fixing groove 71 by the second spring 10 again. The second enclosure 4 can then be opened from the first enclosure 2.

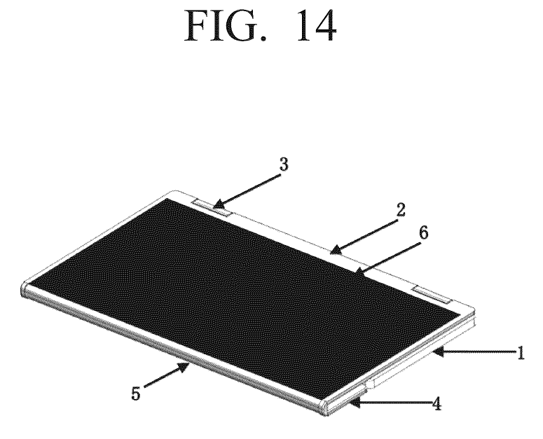

FIG. 14 is a schematic view showing the foldable computing device in a pad mode according to an embodiment of the disclosure. The foldable computing device can be used as a pad when the first enclosure 2 and the second enclosure 4 are both opened to the 360° position.

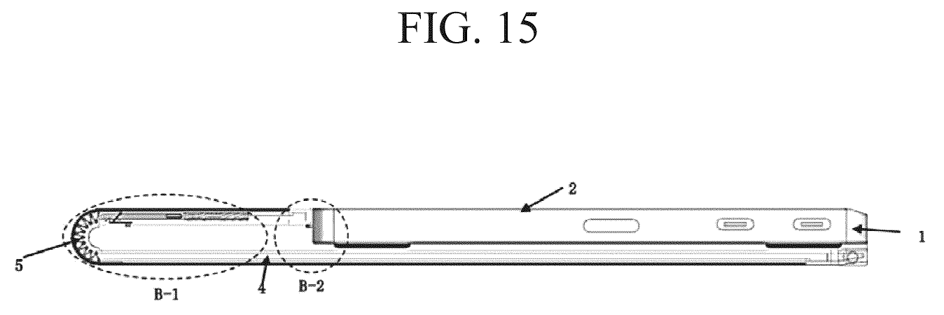

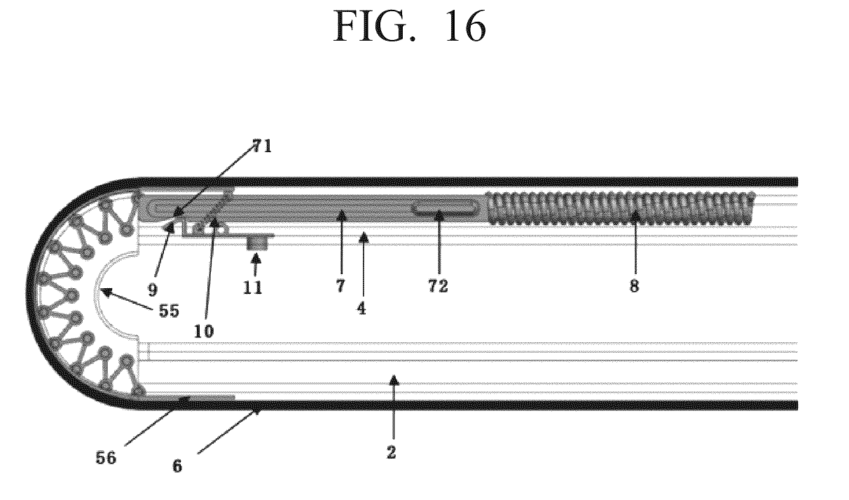

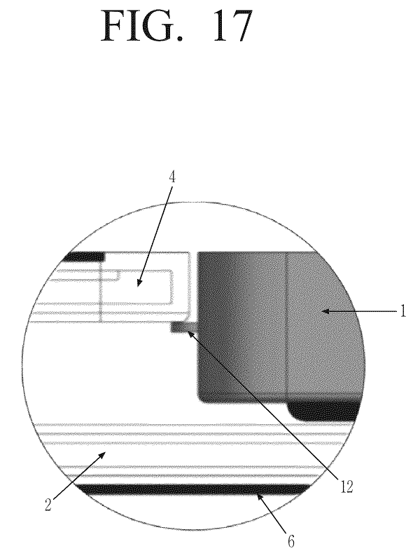

FIG. 15 is a side view showing the foldable computing device in a pad mode according to an embodiment of the disclosure. FIG. 16 is a partially enlarged view showing the portion B-1 of FIG. 15. FIG. 17 is a partially enlarged view showing the portion B-2 of FIG. 15. In an embodiment, if a user pushes the operation part 72 upwards, the movable bolt 7 will retract from the first enclosure 2 into the second enclosure 4 under the elastic force of the first spring 8, and the fixing hook 9 will be drawn into the fixing groove 71 by the second spring 10 again. The second enclosure 4 can then be closed reversely onto the first enclosure 2. In an embodiment, the supporter 12 is configured to support the second enclosure 4 after the second enclosure 4 is closed onto the first enclosure 2 and to prevent the flexible display panel 6 from over bending an incurring permanent damage.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A foldable computing device comprising:
a host case;
a first enclosure pivotally coupled to a back side of the host case via a first hinge;
a second enclosure pivotally coupled to a front side of the first enclosure via a second hinge;
a flexible display panel attached to the first enclosure and the second enclosure; and
a locking unit between the first enclosure and the second enclosure, wherein the locking unit is configured to lock the first enclosure and the second enclosure together after the second enclosure is opened from the first enclosure, or to unlock the first enclosure and the second enclosure before the second enclosure is closed onto the first enclosure.

2. The foldable computing device of claim 1, wherein the first hinge and the second hinge each comprise a 360 degree range of rotation.

3. The foldable computing device of claim 1, wherein a first end of the second hinge is pivotally connected with the front side of the first enclosure, and a second end of the second hinge is pivotally connected with the back side of the second enclosure.

4. The foldable computing device of claim 3,
wherein the second hinge comprises a first hinge plate, a second hinge plate, and a pin,
wherein each of the first and the second hinge plates comprise a plate body and a plurality of pin lugs distributed along each side of the plate body,
wherein the plurality of pin lugs of the first and the second hinge plates interlock with one another, and the pin is inserted through the interlocked pluralities of pin lugs of the first and the second hinge plates, and
wherein the first and the second hinge plates are pivotally connected with each other.

5. The foldable computing device of claim 4, further comprising:
an outer protective cover on an outer side of the second hinge; and
a flexible screen supporting plate under the flexible display panel,
wherein the flexible screen supporting plate is arranged on an inner side of the second hinge.

6. The foldable computing device of claim 5,
wherein a notch is formed between the first enclosure and the second enclosure, and
wherein the flexible screen supporting plate is movably arranged within the notch.

7. The foldable computing device of claim 5,
wherein the locking unit comprises a first movable bolt movably arranged inside the second enclosure, and
wherein the first movable bolt is configured to protrude from the second enclosure and lock with the first enclosure after the second enclosure is opened from the first enclosure, and the first movable bolt is configured to retract from the first enclosure into the second enclosure before the second enclosure is closed onto the first enclosure.

8. The foldable computing device of claim 7,
wherein the locking unit further comprises a second movable bolt movably arranged inside the second enclosure,
wherein the second movable bolt is configured to protrude from the second enclosure and lock with the first enclosure after the second enclosure is opened from the first enclosure, and the second movable bolt is configured to retract from the first enclosure into the second enclosure before the second enclosure is closed onto the first enclosure, and
wherein the first and the second movable bolt are respectively arranged on each side of the second hinge, and both the second hinge and the first and the second movable bolts are covered by the outer protective cover.

9. The foldable computing device of claim 7,
wherein the locking unit further comprises:
a first spring on a back end of the first movable bolt;
a fixing hook disposed within the second enclosure and a second spring, wherein the fixing hook is connected with a front side of the flexible screen supporting plate via the second spring; and
a release button connected to an end of the fixing hook,
wherein a front end of the first movable bolt comprises a fixing groove, and the fixing hook is configured to be drawn into the fixing groove by the second spring,
wherein, in response to the release button being pressed, the fixing hook is configured to move out of the fixing groove, and
wherein, in response to the fixing hook moving out of the fixing groove, the first spring is configured to cause the first movable bolt to elastically protrude from the second enclosure under an elastic force of the first spring and to insert into a corresponding connecting hole in the first enclosure.

10. The foldable computing device of claim 9,
wherein the first movable bolt comprises an operation part outside the second enclosure, and
wherein, in response to the operation part being pushed, the first movable bolt is configured to retracts from the first enclosure into the second enclosure under the elastic force of the first spring, and the fixing hook is configured to be drawn into the fixing groove by the second spring.

11. The foldable computing device according to claim 1, wherein the front of the host case comprises a supporter configured to support the second enclosure after it is closed onto the first enclosure.

12. The foldable computing device of claim 1, wherein the host case comprises a keyboard and a hidden touchpad.

13. The foldable computing device of claim 1, wherein the host case comprises a motherboard and a power supply system.

14. A foldable computing device comprising:
a first enclosure and a second enclosure, wherein the second enclosure is pivotally coupled to a front side of the first enclosure; and
a locking unit between the first enclosure and the second enclosure,
wherein the locking unit is configured to lock the first enclosure and the second enclosure together after the second enclosure is opened from the first enclosure, or to unlock the first enclosure and the second enclosure before the second enclosure is closed onto the first enclosure,
wherein the locking unit comprises a first movable bolt movably arranged inside the second enclosure, and
wherein the first movable bolt is configured to protrude from the second enclosure and lock with the first enclosure after the second enclosure is opened from the first enclosure, and the first movable bolt is configured to retract from the first enclosure into the second enclosure before the second enclosure is closed onto the first enclosure.

15. The foldable computing device of claim 14, further comprising:
a hinge; and
an outer protective cover,
wherein the locking unit further comprises a second movable bolt movably arranged inside the second enclosure,
wherein the second movable bolt is configured to protrude from the second enclosure and lock with the first enclosure after the second enclosure is opened from the first enclosure, and the second movable bolt is configured to retract from the first enclosure into the second enclosure before the second enclosure is closed onto the first enclosure, and
wherein the first and the second movable bolts are respectively arranged on each side of the hinge, and both the hinge and the first and the second movable bolts are covered by the outer protective cover.

16. The foldable computing device of claim 15, further comprising:
a flexible display panel attached to the first enclosure and the second enclosure; and
a flexible screen supporting plate under the flexible display panel;
wherein the first enclosure and the second enclosure are pivotally connected via the hinge, the outer protective cover is on an outer side of the hinge, and the flexible screen supporting plate is arranged on an inner side of the hinge,
wherein the locking unit further comprises a first and a second locking assembly, wherein each of the first and the second locking assemblies comprises:
one of the first and the second movable bolts, wherein each of the first and the second movable bolts comprises a fixing groove, a first spring on a back end of the one of the first and the second movable bolts;
a fixing hook disposed within the second enclosure;
a second spring; and
a release button, and
wherein, for each of the first and the second locking assemblies:
the fixing hook is connected to a front side of the flexible screen supporting plate via the second spring, and the release button is connected to an end of the fixing hook,
the fixing hook is configured to be drawn into the fixing groove by the second spring,
in response to the release button being pressed, the fixing hook is configured to move out of the fixing groove, and
in response to the fixing hook moving out of the fixing groove, the first spring is configured to cause the one of the first and the second movable bolt to elastically protrude from the second enclosure under an elastic force of the first spring and to insert into a corresponding connecting hole in the first enclosure.

17. The foldable computing device of claim 16,
wherein each of the first and the second movable bolts comprises an operation part outside the second enclosure, and
wherein, for each of the first and the second locking assemblies, in response to the operation part being pushed, the one of first and the second movable bolts is configured to retract from the first enclosure into the second enclosure under the elastic force of the first spring, and the fixing hook is configured to be drawn into the fixing groove by the second spring.

18. The foldable computing device of claim 16, wherein the hinge comprises a 360 degree range of rotation.

19. The foldable computing device of claim 16, wherein a first end of the hinge is pivotally connected with a front side of the first enclosure, and a second end of the hinge is pivotally connected with a back side of the second enclosure.

20. The foldable computing device of claim 19,
wherein the hinge comprises a first hinge plate, a second hinge plate, and a pin,
wherein each of the first and the second hinge plates comprise a plate body and a plurality of pin lugs distributed along each side of the plate body,
wherein the plurality of pin lugs of the first and the second hinge plates interlock with one another, and the pin is inserted through the interlocked pluralities of pin lugs of the first and the second hinge plates, and
wherein the first and the second hinge plates are pivotally connected with each other.
